(19) United States
(12) Patent Application Publication
(10) Pub. No.: US 2012/0275355 A1
(43) Pub. Date: Nov. 1, 2012

(54) METHOD AND APPARATUS FOR RESOURCE ALLOCATION AND METHOD AND APPARATUS FOR RECEIVING RESOURCE ALLOCATION INFORMATION SIGNAL

(75) Inventors: Jisoo PARK, Daejeon (KR); Sook Jin Lee, Daejeon (KR); Youn Ok Park, Daejeon (KR); Dong Seung Kwon, Daejeon (KR)

(73) Assignee: ELECTRONICS AND TELECOMMUNICATIONS RESEARCH INSTITUTE, Daejeon (KR)

(21) Appl. No.: 13/458,948

(22) Filed: Apr. 27, 2012

(30) Foreign Application Priority Data
Apr. 27, 2011 (KR) 10-2011-0039680
Apr. 27, 2012 (KR) 10-2012-0044327

(51) Int. Cl. H04W 72/04; H04J 1/00

(52) U.S. Cl. 370/281; 370/329

(57) ABSTRACT

A method of allocating a resource by a base station is provided. The base station allocates a plurality of radio resources for transmitting a plurality of data bursts to a plurality of subframes in one frame, respectively, and generates a resource allocation information signal including allocation information on the plurality of radio resources. The base station transmits the resource allocation information signal to a mobile station through one subframe.

### CROSS-REFERENCE TO RELATED APPLICATION

This application claims priority to and the benefit of Korean Patent Application Nos. 10-2011-0039680 and 10-2012-0044327 filed in the Korean Intellectual Property Office on Apr. 27, 2011 and Apr. 27, 2012, the entire contents of which are incorporated herein by reference.

### BACKGROUND OF THE INVENTION

(a) Field of the Invention

The present invention generally relates to a resource allocation method and apparatus, and a receiving method and apparatus of a resource allocation information signal.

(b) Description of the Related Art

A wideband wireless access system is a next generation wireless communication system, and supports a hybrid automatic repeat request (HARQ) scheme to achieve high speed data packet transmission, low delay, and transmission reliability. Further, the wideband wireless access system uses a multi-input multi-output (MIMO) scheme for improving transmitting/receiving efficiency of data by multiple transmitting antennas and multiple receiving antennas.

In general, a base station schedules radio resources that are used at uplink and downlink data transmission. The wideband wireless access system uses a transmission time interval (TTI) as a transmission time unit. The TTI is a transmission duration of a physical layer for an encoded packet over a radio air interface, and is represented as slot(s) or subframe(s). That is, one TTI is the transmission duration of a packet (subpacket or data burst) occupying a length of one slot or subframe, and n TTI is the transmission duration of a packet occupying a length of n slots or subframes.

The data burst may be transmitted over one subframe, or may be transmitted over a plurality of consecutive subframes. For transmission of a data burst in one subframe, the duration of the data burst is referred to as one TTI (OTTI) or a default TTI. For transmission of a data burst over the consecutive subframes, the duration of the data burst is referred to as a long TTI (LTTI). For example, for an FDD mode, the LTTI is defined as a length of four subframes.

Recently, since various traffic services are generated in the wideband wireless access system, various resource allocation methods should be supported to efficiently use radio resources. A conventional dynamic resource allocation method or dynamic scheduling method allocates resources to users in frame-by-frame basis or subframe-by-subframe basis, and individually and frequently transmits resource allocation information signal to each user in a predetermined frame or subframe according to a state of radio channels. The overhead occurs by radio resources corresponding to the resource allocation information signal. As a result, available radio resources for providing users that receive the various traffic services are reduced.

On the other hand, if a data burst is transmitted over consecutive subframes, that is, when the data burst is transmitted by the LTTI, the resource allocation information signal is transmitted in only the first subframe and only the data burst is transmitted in the other subframes. Accordingly, the overhead occurred by the resource allocation information signal can be reduced. However, when an error of the data burst occurs at any one subframe, radio resources of entire data burst packet length corresponding to the LTTI length should be re-allocated. Therefore, the waste of radio resources is increased by the retransmission corresponding to the LTTI length. As a result, a packet transmission is delayed, and transmission speed efficiency gets worse.

### SUMMARY OF THE INVENTION

Embodiments of the present invention provide a resource allocation method and apparatus, and a receiving method and apparatus of a resource allocation information signal, for improving transmission efficiency.

According to an embodiment of the present invention, a method of allocating a resource is provided by a base station. The method includes allocating a plurality of radio resources for transmitting a plurality of data bursts to a plurality of subframes in one frame, respectively, generating a resource allocation information signal including allocation information on the plurality of radio resources, and transmitting the resource allocation information signal to a mobile station through one subframe.

A length of each data burst may be a transmission time interval corresponding to one subframe.

The one frame may include a plurality of downlink subframes and a plurality of uplink subframes. In this case, the one subframe may be a subframe having an index I among the plurality of downlink subframes, and a data burst having an index r among the plurality of data bursts may be transmitted at a subframe having an index Iᵣ among the plurality of downlink subframes. Here, Iᵣ is defined as (I+r), and I and r each are an integer that is greater than or equal to 0.

The method may further include receiving a feedback signal on the data burst having the index r from the mobile station. In this case, the feedback signal may be transmitted at a subframe having an index nᵣ among the plurality of uplink subframes. For D>U, nᵣ may be defined as Equation 1. For D≦U, nᵣ may be defined as Iᵣ−K₂. D represents a number of the plurality of downlink subframes, U represents a number of the plurality of uplink subframes, K₁ is defined as floor((D−U)/2), K₂ is defined as −ceil((U−D)/2), and r starts from 0 and numbers up to D−I−1.

$${n}_{r} = \{ \begin{matrix} 0 , & for 0 \leq {l}_{r} < {K}_{1} \\ {l}_{r} - {K}_{1} , & for {K}_{1} \leq {l}_{r} < U + {K}_{1} \\ U - 1 , & for U + {K}_{1} \leq {l}_{r} < D\end{matrix} \qquad ( 1 )$$

The one frame may include a plurality of FDD subframes. In this case, the one subframe may be a subframe having an index I among the plurality of FDD subframes, and a data burst having an index r among the plurality of data bursts may be transmitted at an FDD subframe having an index Iᵣ among the plurality of FDD subframes. Here, Iᵣ is defined as (I+r), and I and r each are an integer that is greater than or equal to 0.

The method may further include receiving a feedback signal on the data burst having the index r from the mobile station. In this case, the feedback signal may be transmitted at an FDD subframe having an index nᵣ among the plurality of FDD subframes, and nᵣ may be defined as ceil(Iᵣ+F/2) mod F. F represents a number of the plurality of FDD subframes, and r starts from 0 and numbers up to F−I−1.

The method may further include transmitting a feedback signal on a data burst having an index r among the plurality of data bursts to the mobile station, and the one frame may include a plurality of downlink subframes and a plurality of uplink subframes. In this case, the one subframe may be a subframe having an index I among the plurality of downlink subframes, and the feedback signal may be transmitted at a subframe having an index Iᵣ among the plurality of uplink subframes. For D≧U, Iᵣ may be defined as Equation 2. For D≦U, Iᵣ may be defined as Equation 3. D represents a number of the plurality of downlink subframes, U represents a number of the plurality of uplink subframes, K₁ is defined as floor((D−U)/2), K₂ is defined as −ceil((U−D)/2), and r starts from 0 and numbers up to D−I−1.

$$\begin{matrix}{l}_{r} = \{ \begin{matrix}l + r + {K}_{1} , & for l < {K}_{1} \\ l + r , & for l \geq {K}_{1}\end{matrix} \\ r = 0 , … , ( U + {K}_{1} - l - 1 ) & ( 2 ) \\ {l}_{r} = \{ \begin{matrix}l + r , & for r < D - 1 \\ D - 1 , & for r \geq D - 1\end{matrix} \\ r = 0 , … , ( U + {K}_{2} - l - 1 ) & ( 3 )\end{matrix}$$

The data burst having the index r may be transmitted at a subframe having an index mᵣ among the plurality of uplink subframes. For D≧U, mᵣ may be defined as Equation 4. For D<U, mᵣ may be defined as Equation 5.

$$\begin{matrix}{m}_{r} = \{ \begin{matrix}0 , & for 0 \leq {l}_{r} < {K}_{1} \\ {l}_{r} - {K}_{1} , & for {K}_{1} \leq {l}_{r} < U + {K}_{1} \\ U - 1 , & for U + {K}_{1} \leq {l}_{r} < D\end{matrix} & ( 4 ) \\ {m}_{r} = \{ \begin{matrix}{l}_{r} - K , & for r < D - 1 \\ \{ {l}_{r} - K , … , U - 1 \} , & for r \leq D - 1\end{matrix} & ( 5 )\end{matrix}$$

The method may further include retransmitting the data burst having the index r at a subframe having the index mᵣ among a plurality of uplink subframes of a next frame when the feedback signal is a NACK.

The method may further include transmitting a feedback signal on a data burst having an index r among the plurality of data bursts to the mobile station, and the one frame may include a plurality of FDD subframes. In this case, the one subframe may be a subframe having an index I among the plurality of FDD subframes, and the feedback signal may be transmitted at a subframe having an index Iᵣ among a plurality of FDD subframes included in a next frame of the one frame. Here, Iᵣ is defined as (I+r), and I and r each are an integer that is greater than or equal to 0.

The data burst having the index r may be transmitted at an FDD subframe having an index mᵣ among the plurality of FDD subframes, and mᵣ may be defined as ceil(Iᵣ+F/2) mod F. F represents a number of the plurality of FDD subframes, and r starts from 0 and numbers up to F−I−1.

The method may further include retransmitting the data burst having the index r at an FDD subframe having the index mᵣ among the plurality of FDD subframes of the next frame when the feedback signal is a NACK.

According to another embodiment of the present invention, a method of receiving a resource allocation information signal from a base station is provided by a mobile station. The method includes receiving the resource allocation information signal from the base station through one subframe, and acquiring the resource allocation information signal at the one subframe. The resource allocation information signal includes allocation information on a plurality of radio resources, for a plurality of data bursts, which are allocated to a plurality of subframes in one frame, respectively.

A length of each data burst may be a transmission time interval corresponding to one subframe.

The one frame may include a plurality of downlink subframes and a plurality of uplink subframes. In this case, the one subframe may be a subframe having an index I among the plurality of downlink subframes, and a data burst having an index r among the plurality of data bursts is transmitted at a subframe having an index Iᵣ among the plurality of downlink subframes. Here, Iᵣ is defined as (I+r), and I and r each are an integer that is greater than or equal to 0.

The one frame may include a plurality of FDD subframes. In this case, the one subframe may be a subframe having an index I among the plurality of FDD subframes, and a data burst having an index r among the plurality of data bursts is transmitted at an FDD subframe having an index Iᵣ among the plurality of FDD subframes. Here, Iᵣ is defined as (I+r), and I and r each are an integer that is greater than or equal to 0.

The method may further include receiving a feedback signal on a data burst having an index r among the plurality of data bursts from the base station, and the one frame may include a plurality of downlink subframes and a plurality of uplink subframes. In this case, the one subframe may be a subframe having an index I among the plurality of downlink subframes, and the feedback signal may be transmitted at a subframe having an index Iᵣ among the plurality of uplink subframes. Here, Iᵣ is defined as (I+r), and I and r each are an integer that is greater than or equal to 0.

The method may further include receiving a feedback signal on a data burst having an index r among the plurality of data bursts from the base station, and the one frame may include a plurality of FDD subframes. The one subframe may be a subframe having an index I among the plurality of FDD subframes, and the feedback signal may be transmitted at a subframe having an index Iᵣ among a plurality of FDD subframes included in a next frame of the one frame. Here, Iᵣ is defined as (I+r), and I and r each are an integer that is greater than or equal to 0.

According to yet another embodiment of the present invention, an apparatus for allocating a resource is provided. The apparatus includes a controller and a transceiver. The controller allocates a plurality of radio resources for transmitting a plurality of data bursts to a plurality of subframes in one frame, respectively, and generates a resource allocation information signal including allocation information on the plurality of radio resources. The transceiver transmits the resource allocation information signal to a mobile station through one subframe.

According to further embodiment of the present invention, a receiving apparatus including a transceiver and a controller is provided. The transceiver receives a resource allocation information signal from a base station through one subframe, and the controller acquires the resource allocation information signal at the one subframe. The resource allocation information signal includes allocation information on a plurality of radio resources, for a plurality of data bursts, which are allocated to a plurality of subframes in one frame, respectively.

### BRIEF DESCRIPTION OF THE DRAWINGS

FIG. 1 shows a frame structure of a wireless access system according to an embodiment of the present invention.

FIG. 2 shows an example of a downlink resource allocation method in a TDD frame structure.

FIG. 3 shows an example of a downlink HARQ operation for a downlink resource allocation method of a LTTI data burst in a TDD frame structure.

FIG. 4 shows an example of an uplink resource allocation method in a TDD frame structure.

FIG. 5 shows an example of an uplink HARQ operation for an uplink resource allocation method of a LTTI data burst in a TDD frame structure.

FIG. 6 is a flowchart showing a downlink resource allocation method according to an embodiment of the present invention.

FIG. 7 shows an example of a downlink resource allocation method according to an embodiment of the present invention.

FIG. 8 shows an example of an HARQ process in a downlink resource allocation method according to an embodiment of the present invention.

FIG. 9 is a flowchart showing an uplink resource allocation method according to an embodiment of the present invention.

FIG. 10 shows an example of an uplink resource allocation method according to an embodiment of the present invention.

FIG. 11 shows an example of an HARQ process in an uplink resource allocation method according to an embodiment of the present invention.

FIG. 12 is a block diagram showing a resource allocation apparatus according to an embodiment of the present invention.

FIG. 13 is a block diagram showing a receiving apparatus of a resource allocation information signal according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, a mobile station (MS) may indicate a terminal, a mobile terminal (MT), an advanced mobile station (AMS), a high reliability mobile station (HR-MS), a subscriber station (SS), a portable subscriber station (PSS), an access terminal (AT), and user equipment (UE), and it may include entire or partial functions of the terminal, the MT, the AMS, the HR-MS, the SS, the PSS, the AT, and the UE.

Furthermore, a base station (BS) may indicate an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, and a high reliability relay station (HR-RS) serving as a base station, and it may include entire or partial functions of the ABS, the HR-BS, the node B, the eNodeB, the AP, the RAS, the BTS, the MMR-BS, the RS, and the HR-RS.

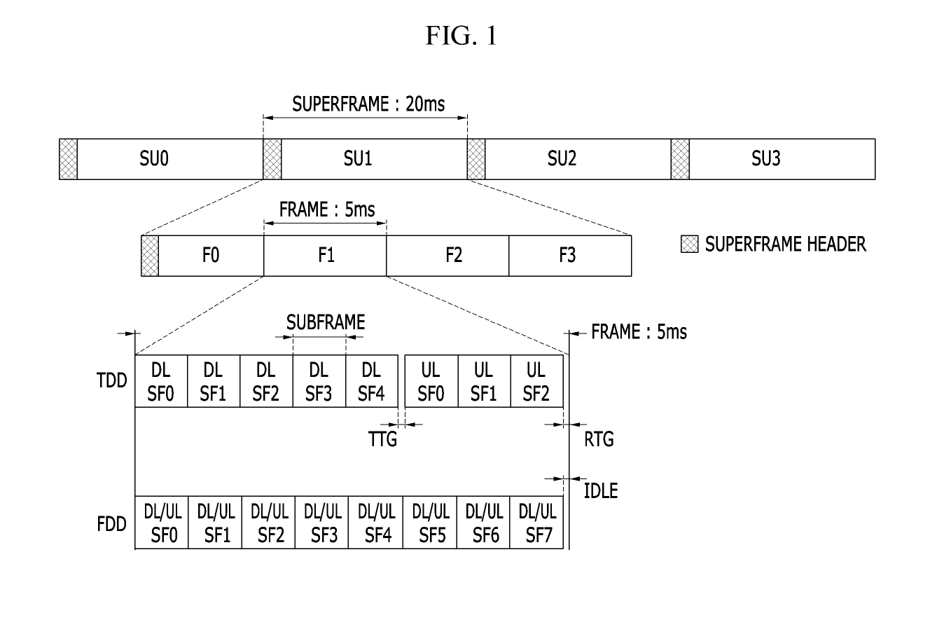

FIG. 1 shows a frame structure of a wireless access system according to an embodiment of the present invention.

Referring to FIG. 1, a plurality of superframes SU0 to SU3 are consecutive. Each superframe includes a plurality of frame F0, F1, F2, and F3, and each frame includes a plurality of subframes. A superframe header is located at a head of each superframe. It is assumed in FIG. 1 that the number of frames is 4 in one superframe and the number (F) of subframes is 8 in one frame.

In time division duplex (TDD) mode, a plurality of subframes of a TDD frame are divided into DL subframes DLSF0 to DLSF4 and UL subframes ULSF0 to ULSF2. A transmit/receive transition gap (TTG) is inserted in a position where the DL subframe and the UL subframe are switched, and a receive/transmit transition gap (RTG) is inserted in an end of the TDD frame. It is assumed in FIG. 1 that a ratio of the DL subframes to the UL subframes, i.e., D:U is 5:3 in the frame and an HARQ processing time of a base station or a mobile station is 3 subframes. That is, it is assumed that a processing time during which the mobile station receives and decodes a data burst or a MAP transmitted by the base station and transmits a feedback signal or a data burst in an uplink is 3 subframes. Further, it is assumed that a processing time during which the base station receives and decodes a data burst transmitted by the mobile station and transmits a feedback signal in a downlink is 3 subframes and a processing time during which the base station receives and decodes an uplink HARQ feedback for a downlink data burst is 3 subframes.

In a frequency division duplex (FDD) mode, all subframes SF0 to SF7 of an FDD frame can be used in a downlink and an uplink (DL/UL). An idle interval (IDLE) is located at an end of the FDD frame.

Table 1 represents structures of the TDD frame and the FDD frame according to a channel bandwidth (channel BW) and a CP ratio.

TABLE 1

| | | Channel BW (MHz) | | |
|---|---|---|---|---|
| CP Ratio | | 7 | 8.75 | 5, 10, 20 |
| FDD(F) | G = ⅛ | 5 | 7 | 8 |
| | G = 1/16 | 6 | | |
| TDD(D:U) | G = ⅛ | 3:2, 2:3 | 5:2, 4:3, 3:4 | 8:0, 6:2, 5:3, 4:4, 3:5 |
| | G = 1/16 | 4:2, 3:3 | | |
| G = ¼ FDD (F) | | 5 | 6 | 7 |
| TDD(D:U) | G = ¼ | 3:2, 2:3 | 4:2, 3:3, 2:4 | 5:2, 4:3, 3:4 |

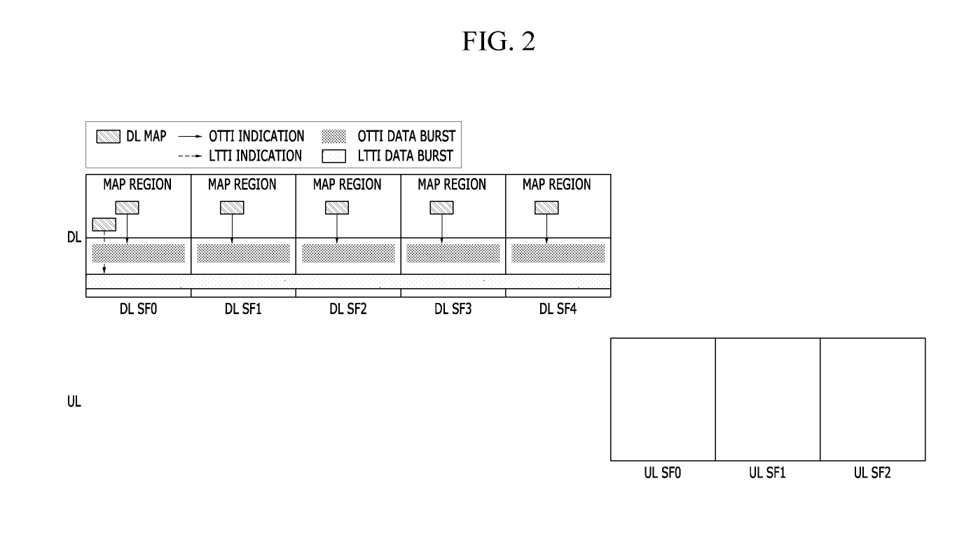

Next, a dynamic resource allocation method in a general wireless access system is described with reference to FIG. 2 to FIG. 5.

FIG. 2 shows an example of a downlink resource allocation method in a TDD frame structure.

Referring to FIG. 2, when a downlink data burst is allocated and transmitted to a certain downlink subframe according to the downlink resource allocation method, a downlink resource allocation information signal (DL MAP) is transmitted through a downlink information signal allocation region (MAP region) that is located at the same location as the allocated downlink data burst. The DL MAP provides each user with allocation information of downlink data bursts, and includes all resource allocation control information for decoding data bursts allocated to a corresponding downlink subframe.

When, at the certain downlink subframe, a base station allocates a downlink radio resource to a certain user (mobile station) by a dynamic resource allocation method, for transmitting a downlink data burst encoded with an OTTI length, the DL MAP and the downlink data burst are transmitted as the same one subframe. The same mechanism is applied to a resource allocation method of other downlink subframes.

As an example shown in FIG. 2, when the downlink data bursts with the OTTI length that are consecutive over all downlink subframes or some consecutive downlink subframes is allocated by the dynamic resource allocation method, the DL MAP is transmitted again at a subframe that is consecutive and adjacent to a previous resource allocation. Accordingly, the DL MAPs corresponding to the number of downlink data bursts are needed.

An LTTI transmission of a downlink data burst at a certain frame transmits one encoded downlink data burst, with the same resource size and at the same position, over a plurality of downlink subframes using one DL MAP, and transmits a data burst with an LTTI length. A plurality of MAPs required to transmit data bursts over consecutive subframes can be reduced to one MAP such that a gain of the radio resource can be improved by a decrease of the overhead. However, when the downlink data burst is transmitted with the LTTI length, a transmission speed is delayed and radio resources are wasted at a retransmission.

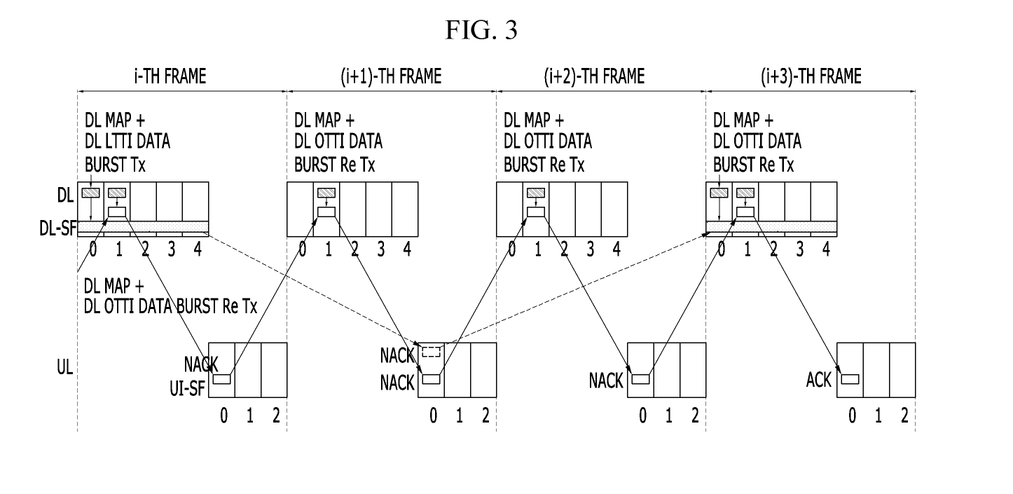

FIG. 3 shows an example of a downlink HARQ operation for a downlink resource allocation method of a LTTI data burst in a TDD frame structure.

Referring to FIG. 3, when a downlink LTTI data burst is retransmitted, that is, when a transmission error occurs at any one of downlink subframes (for example, downlink subframe #1) and a retransmission is required, the entire data burst should be retransmitted with an LTTI length. Accordingly, the waste of radio resources due to the retransmission is increased compared with the OTTI data burst transmission, and a transmission completion time is delayed by retransmission timing such that transmission latency is increased.

When the OTTI data burst is transmitted, HARQ timings for a transmission of an HARQ feedback such as an ACK/NACK according to decoding success or decoding failure of receiving side and a retransmission (ReTx) of a data burst (HARQ subpacket) may be defined as Table 2 and Table 3.

Table 2 represents FDD and TDD downlink HARQ timings, and Table 3 represents FDD and TDD uplink HARQ timings.

TABLE 2

| | FDD | TDD |
|---|---|---|
| DL HARQ | m = l | m = l |
| Subpacket | l is the reference to the DL | l is the reference to the DL subframe, |
| (data burst) | subframe, starting from 0 for the | starting from 0 for the first DL subframe |
| Tx | first DL subframe and numbering up | and numbering up to D-1, where the |
| | to F-1, where the MAP for one TTI | MAP for one TTI transmission is |
| | transmission is transmitted. | transmitted. |
| | m is the reference to the DL | m is the reference to the DL subframe, |
| | subframe, starting from 0 for the | starting from 0 for the first DL subframe |
| | first DL subframe and numbering up | and numbering D-1, where HARQ |
| | to F-1, where HARQ subpacket | subpacket begins its transmission. |
| | begins its transmission. | |
| UL HARQ Feedback Tx | n = ceil(m + F/2) mod F n is the reference for the UL subframe, starting from 0 for the first uplink subframe and numbering up to (F-1). F is the number of subframes by the frame configuration. | For D > U $\begin{matrix}n = \{ \begin{matrix}0 , & for 0 \leq m < K \\ m - K , & for K \leq m < U + K \\ U - 1 , & for U + K \leq m < D\end{matrix} \\ where K = floor ( ( D - U ) / 2 ) , for D > U\end{matrix}$ for D ≦ U n = m − K where, K = − ceil(U − D)/2), for D ≦ U n is the reference for the UL subframe, starting from 0 for the first uplink subframe and numbering up to (U-1), where the HARQ acknowledgement is sent. |

TABLE 3

| | | |
|---|---|---|
| UL HARQ Subpacket Tx | m = ceil (l + F/2) mod F m is the reference to the UL subframe, starting from 0 for the first uplink subframe and numbering up to (F-1), where HARQ subpacket begins its transmission F is the number of subframes by the frame configuration. l is the reference to the DL subframe, starting from 0 for the first DL subframe and numbering up to (F-1), where the MAP is transmitted or the HARQ acknowledgement is sent. | For D ≧ U $\begin{matrix}m = \{ \begin{matrix}0 , & for 0 \leq l < K \\ l - K , & for K \leq l < U + K \\ U - 1 , & for U + K \leq l < D\end{matrix} \\ where K = floor ( ( D - U ) / 2 ) , for D \geq U\end{matrix}$ For D < U $\begin{matrix}m = \{ \begin{matrix}\{ 0 , … , l - K \} , & for l = 0 \\ l - K , & for 0 < l < D - 1 \\ \{ l - K , … , U - 1 \} , & for l = D - 1\end{matrix} \\ where K = - ceil ( U - D ) / 2 ) , for D > U\end{matrix}$ For long TTI m = 0 l is the reference to the DL subframe, starting from 0 for the first DL subframe and numbering up to (D-1), where the MAP is transmitted or the HARQ acknowledgement is sent. m is the reference to the DL subframe, starting from 0 for the first DL subframe and numbering up to (U-1), where HARQ subpacket begins its transmission |
| DL HARQ | n = l | n = l |
| feedback | | |
| Tx | | |
| UL HARQ | m | m |
| Subpacket | | |
| (data burst) | | |
| ReTx | | |

In Table 2 and Table 3, a parameter I represents an index to a subframe where a MAP including resource allocation information is transmitted. The parameter I starts from 0 for the first downlink subframe index, and numbers up to (D−1) in the TDD mode and to (F−1) in the FDD mode. The parameter I for UL HARQ may indicate an index to a downlink subframe where the HARQ feedback is transmitted according to a synchronous HARQ process.

A parameter m represents an index to a subframe where an HARQ subpacket (data burst) begins its transmission. For the transmission of the downlink data burst (HARQ subpacket), the parameter m starts from 0 for the first downlink subframe index, and numbers up to (D−1) in the TDD mode and to (F−1) in the FDD mode. For the transmission of the uplink data burst (HARQ subpacket), the parameter m starts form 0 for the first uplink subframe index, and numbers up to (U−1) in the TDD mode and to (F−1) in the FDD mode.

A parameter n represents an index to a subframe where the HARQ feedback is transmitted, i.e., an HARQ feedback subframe index. For the HARQ feedback of the downlink data burst (HARQ subpacket), the parameter n starts from 0 for the first uplink subframe index, and numbers up to (U−1) in the TDD mode and to (F−1) in the FDD mode. For the HARQ feedback of the uplink data burst (HARQ subpacket), the parameter n starts from 0 for the first downlink subframe index, and numbers up to (D−1) in the TDD mode and to (F−1) in the FDD mode.

A “mod” means a modulo operation, and a=(x)mod(y) means that the remainder is “a” when “x” is divided by “y”. A parameter K is a parameter determined for the TDD mode by a system capability such as a channel bandwidth and the number of subframes, and is used to obtain a reference timing interval for determining an HARQ timing operation interval.

A ceil(x) function returns a roundup of a number or an equation indicated at “x”, and the roundup of a certain number is the smallest integer that is greater than or equal to the certain number. A floor(x) function returns a rounddown of a number or an equation indicated at “x”, and the rounddown of a certain number is the greatest integer that is less than or equal to the certain number.

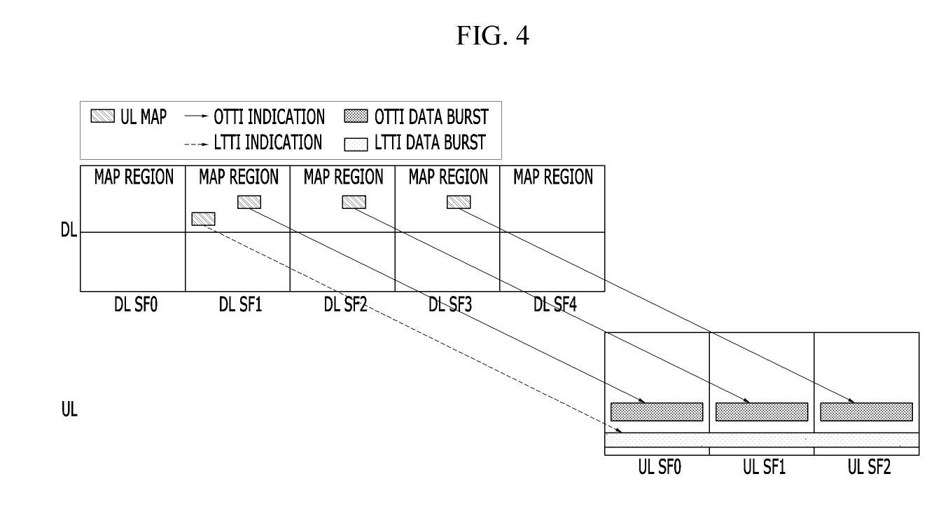

FIG. 4 shows an example of an uplink resource allocation method in a TDD frame structure.

Referring to FIG. 4, when an uplink data burst is allocated and transmitted to a certain uplink subframe according to the uplink resource allocation method, an uplink resource allocation information signal (UL MAP) is transmitted based on an uplink data burst allocation and a timing of a MAP in a downlink information signal allocation region (MAP region). The UL MAP provides each user with allocation information of uplink data bursts, and includes all resource allocation control information for decoding uplink data bursts.

When allocating an uplink radio resource by a dynamic resource allocation method for allowing a certain user (mobile station) to transmit an uplink data burst encoded with an OTTI length, the base station transmits one UP MAP at a certain downlink subframe, and the mobile station one uplink data burst to the base station at a corresponding uplink subframe. The same mechanism is applied to other uplink resource allocations.

As an example shown in FIG. 4, when the uplink data bursts with the OTTI length that are consecutive over all uplink subframes or some consecutive uplink subframes is allocated by the dynamic resource allocation method, the UP MAPs are consecutively transmitted at neighboring downlink subframes such that the uplink data bursts can be consecutively transmitted at the uplink subframes. Accordingly, the UL MAPs corresponding to the number of uplink data bursts are needed.

An LTTI transmission of an uplink data burst at a certain frame transmits one encoded uplink data burst, with the same resource size and at the same position, over a plurality of uplink subframes using one UL MAP, and transmits a data burst with an LTTI length. As described above, a usage of MAPs is reduced such that a gain of the radio resource can be improved by a decrease of the overhead. However, when the uplink data burst is transmitted with the LTTI length, a transmission speed is delayed and radio resources are wasted at a retransmission.

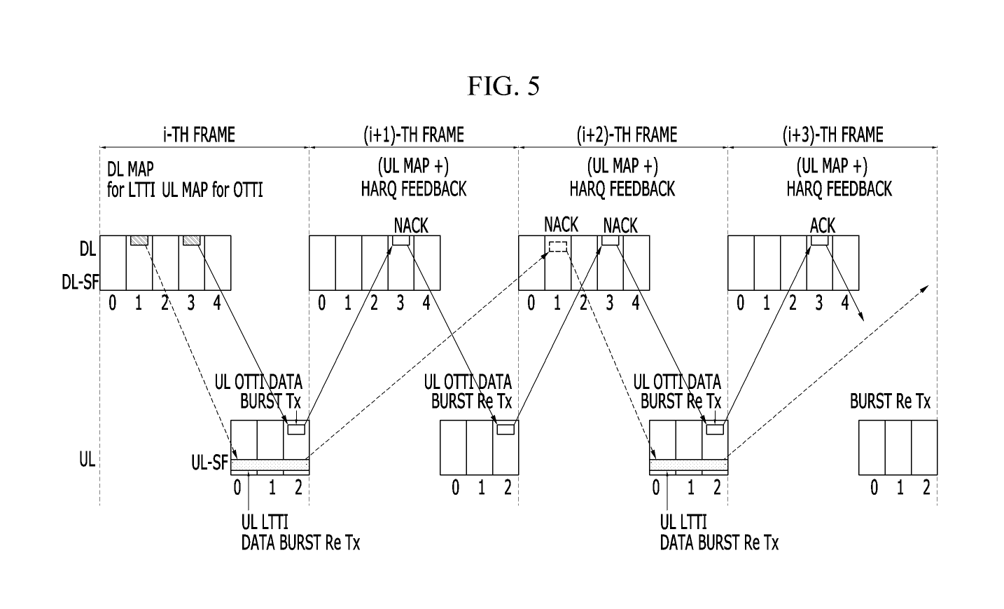

FIG. 5 shows an example of an uplink HARQ operation for an uplink resource allocation method of a LTTI data burst in a TDD frame structure.

Referring to FIG. 5, when an uplink LTTI data burst is retransmitted, that is, when a transmission error occurs at any one of uplink subframes (for example, uplink subframe #2) and a retransmission is required, the entire data burst should be retransmitted with an LTTI length. Accordingly, the waste of radio resources due to the retransmission is increased compared with the OTTI data burst transmission, and a transmission completion time is delayed by retransmission timing such that transmission latency is increased.

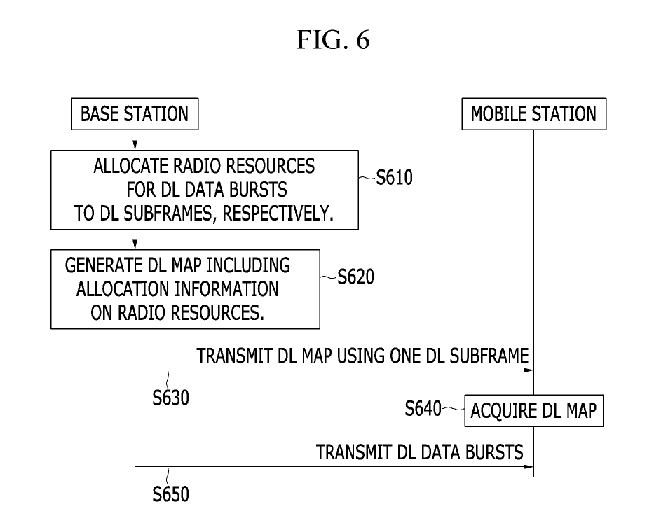

Hereinafter, a resource allocation method according to an embodiment of the present invention is described with reference to FIG. 6 to FIG. 11.

First, a downlink resource allocation method according to an embodiment of the present invention is described with reference to FIG. 6 to FIG. 8.

FIG. 6 is a flowchart showing a downlink resource allocation method according to an embodiment of the present invention.

Referring to FIG. 6, a base station allocates one or more radio resources for transmitting one or more downlink data bursts at one frame to one or more neighboring downlink subframes, respectively (S610). The base station generates a DL MAP including allocation information on the one or more radio resources (S620). The base station transmits the DL MAP at one downlink subframe (S630), and a mobile station acquires the DL MAP at the subframe (S640). The base station consecutively transmits the one or more downlink data bursts at the one or more downlink subframes (S650).

For each of downlink multiple OTTI data bursts allocated to the downlink subframes, an HARQ channel identifier (ID) that is HARQ process (or channel) identification information for identifying a physical (PHY) layer transmission, i.e., the encoded HARQ packet of the data burst may be allocated. When multiple allocation information is included, a channel ID may be identified using an explicit method that the channel ID is included for each of all the data bursts allocated by the DL MAP or an implicit method that the channel ID is assigned to the first data burst of the DL MAP and the channel IDs are sequentially allocated to the other data bursts from among entire channel IDs.

Furthermore, the plurality of downlink data bursts are allocated at the same position and with the same size in the consecutive downlink subframes such that almost the same diversity channel characteristic can be achieved when data packets are transmitted at a resource allocation region of a frequency diversity channel. When the data packets are transmitted at a resource allocation region of a frequency band selection channel that is operated during a predetermined time in a good frequency channel characteristic, transmission efficiency can be improved by a band adaptive modulation & coding (AMC).

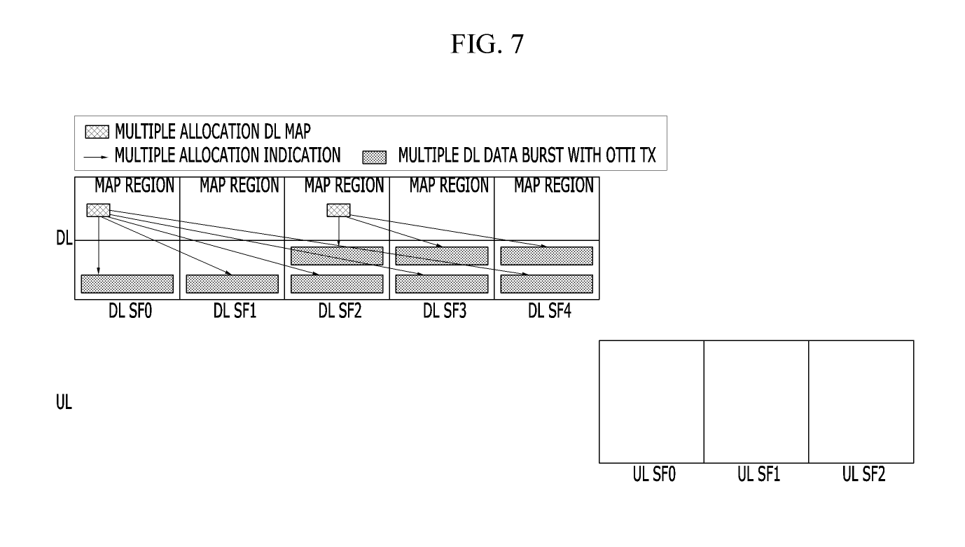

FIG. 7 shows an example of a downlink resource allocation method according to an embodiment of the present invention.

Referring to FIG. 7, a plurality of data bursts that are individually encoded with an OTTI length are allocated over a plurality of subframes, for example 5 subframes, using one DL MAP including multiple allocation control information at a downlink subframe #0 (DL SF0). In addition, a plurality of data bursts that are individually encoded with the OTTI length are allocated over a plurality of subframes, for example 3 subframes, using one DL MAP at a downlink subframe #2 (DL SF2).

Table 4 represents a downlink HARQ timing in a resource allocation method according to an embodiment of the present invention. That is, Table 4 represents a transmitting/receiving timing for a transmission of each downlink data burst and a transmission of each uplink HARQ feedback when at least one downlink data burst is transmitted using one MAP.

TABLE 4

| | FDD | TDD |
|---|---|---|
| DL HARQ Subpacket (data burst) Tx | $\begin{matrix}{m}_{r} = l + r \\ where , \\ r = \{ \begin{matrix}0 , & for single burst \\ 0 , … , ( F - l - 1 ) , & for multiple burst\end{matrix}\end{matrix}$ l is the reference to the DL subframe, starting from 0 for the first DL subframe and numbering up to F-1, where the MAP for single or multiple one TTI transmission is transmitted. r is the index of DL data burst (HARQ subpacket) to be allocated for single or multiple one TTI transmission. mᵣ is the reference to the DL subframe, starting from 0 for the first DL subframe and numbering (F-1), where HARQ subpacket of index r begins its transmission. | $\begin{matrix}{m}_{r} = l + r \\ where , \\ r = \{ \begin{matrix}0 , & for single burst \\ 0 , … , ( D - l - 1 ) , & for multiple burst\end{matrix} - 1\end{matrix}$ is the reference to the DL subframe, starting from 0 for the first DL subframe and numbering up to (D-1), where the MAP for single or multiple one TTI transmission is transmitted. r is the index of DL data burst (HARQ subpacket) to be allocated for single or multiple one TTI transmission. mᵣ is the reference to the DL subframe, starting from 0 for the first DL subframe and numbering (D-1), where HARQ subpacket of index r begins its transmission. |
| UL HARQ feedback Tx | nᵣ = ceil(mᵣ + F/2) mod F nᵣ is the reference for the UL subframe, starting from 0 for the first uplink subframe and numbering up to (F-1), where the HARQ acknowledgement for r-th HARQ subpacket to be transmitted on mᵣ is sent. F is the number of subframes by the frame configuration. | For D > U $\begin{matrix}{n}_{r} = \{ \begin{matrix}0 , & for 0 \leq {m}_{r} < K \\ {m}_{r} - K , & for K \leq {m}_{r} < U + K \\ U - 1 , & for U + K \leq {m}_{r} < D\end{matrix} \\ where K = floor ( ( D - U ) / 2 ) , for D > U\end{matrix}$ For D ≦ U nᵣ = mᵣ − K where, K = -ceil((U − D)/2, for D ≦ U Note: nᵣ is the reference for the UL subframe, starting from 0 for the first uplink subframe and numbering up to (U-1), where the HARQ acknowledgement for r-th HARQ subpacket to be transmitted on mᵣ is sent. |

In Table 4, a parameter I represents an index to a downlink subframe where one DL MAP including downlink resource allocation information for one or more downlink data bursts is transmitted. The parameter I starts from 0 for the first downlink subframe index, and numbers up to (D−1) in the TDD mode and to (F−1) in the FDD mode.

A parameter r represents a burst index to the one or more downlink data bursts. That is, the parameter r is given as r=0 for the FDD mode and TDD mode when the number of the allocated downlink data bursts is 1, and r=0, 1, . . . , (D−I−1) for the TDD mode and r=0, 1, . . . , (F−I−1) for the FDD mode when the plurality of data bursts are multiplely allocated. For example, r=0 represents the burst index for the first data burst, and r=1 represents the burst index for the second data burst among the multiple data bursts.

A parameter mᵣ represents an index to a downlink subframe where a downlink data burst (downlink HARQ subpacket) corresponding to the burst index r is transmitted.

As such, when the plurality of downlink data bursts are multiplely allocated, the index r is determined by the number (D for TDD or F for FDD) of downlink subframes and an index I to the downlink subframe where the DL MAP, which is an allocation information signal of the data bursts, is transmitted. This means that the number of multiple downlink data bursts is determined by the index r.

The maximum number of downlink data bursts that can be transmitted using one DL MAP including multiple allocation information at one frame is a difference between the number of downlink subframes and the index I to the subframe where the DL MAP is transmitted, and is (D−1) for the TDD mode and (F−1) for the FDD mode.

A parameter nᵣ represents an index to a subframe where an HARQ feedback corresponding to the index r is transmitted, i.e., an HARQ feedback subframe index. For the uplink HARQ feedback of the downlink data burst (HARQ subpacket), the parameter nᵣ starts from 0 for the first uplink subframe index, and numbers up to (U−1) in the TDD mode and to (F−1) in the FDD mode.

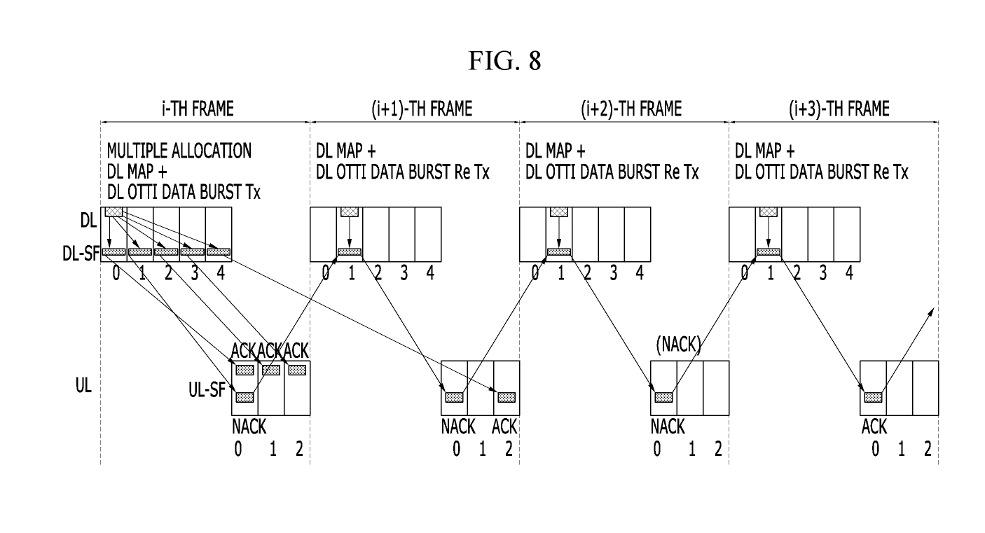

FIG. 8 shows an example of an HARQ process in a downlink resource allocation method according to an embodiment of the present invention.

Referring to FIG. 8, a base station allocates a plurality of data bursts to a mobile station with an OTTI length over a plurality of down subframes, for example 5 down subframes, using one DL MAP including downlink multiple allocation control information at a downlink subframe #0 (DL SF0) of the i-th frame.

When an error occurs at the downlink data burst corresponding to a downlink subframe #1 (DL SF1) of the i-th frame, the mobile station transmits an HARQ feedback which is a NACK signal, and the base station retransmits the corresponding data burst in the (i+1)-th frame which is a next frame.

When the number of retransmissions is 3 as the example of FIG. 8, latency for the mobile station to finally receive all data bursts is 4 frames.

In the example of FIG. 3, because the latency for one transmission of the LTTI data burst is 4 frames, transmitting the data burst by multiple allocation method shown in FIG. 8 is more efficient than the LTTI data burst transmission when the same number of retransmission is used. Furthermore, the multiple allocation method can provide the same transmission speed as an OTTI transmission, and can allocate and transmit/receive multiple data bursts using one MAP thereby reducing the overhead of the DL MAP for a plurality of downlink data burst allocations.

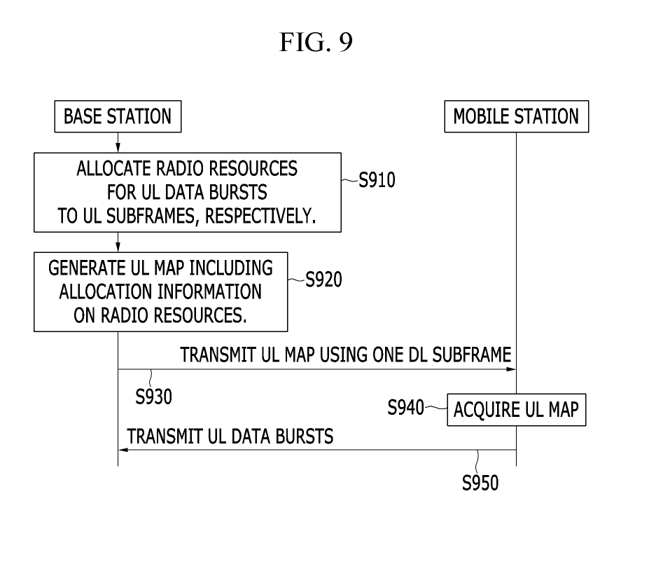

Next, an uplink resource allocation method according to an embodiment of the present invention is described with reference to FIG. 9 to FIG. 11.

FIG. 9 is a flowchart showing an uplink resource allocation method according to an embodiment of the present invention.

Referring to FIG. 9, a base station allocates one or more radio resources for transmitting one or more uplink data bursts at one frame to one or more neighboring uplink subframes, respectively (S910). The base station generates an UP MAP including allocation information on the one or more radio resources (S920). The base station transmits the UL MAP at one downlink subframe (S930), and a mobile station acquires the UL MAP at the subframe (S940). The mobile station transmits the one or more uplink data bursts at the one or more uplink subframes (S950).

For each of uplink multiple OTTI data bursts allocated to the uplink subframes, an HARQ channel ID for identifying a PHY layer transmission. When multiple allocation information is included, a channel ID may be identified using an explicit method that the channel ID is included for each of all the data bursts allocated by the UL MAP or an implicit method that the channel ID is assigned to the first data burst of the UL MAP and the channel IDs are sequentially allocated to the other data bursts from among entire channel IDs.

Furthermore, the plurality of uplink data bursts are allocated at the same position and with the same size in the consecutive uplink subframes such that almost the same diversity channel characteristic can be achieved when data packets are transmitted at a resource allocation region of a frequency diversity channel. When the data packets are transmitted at a resource allocation region of a frequency band selection channel, transmission efficiency can be improved by a band AMC.

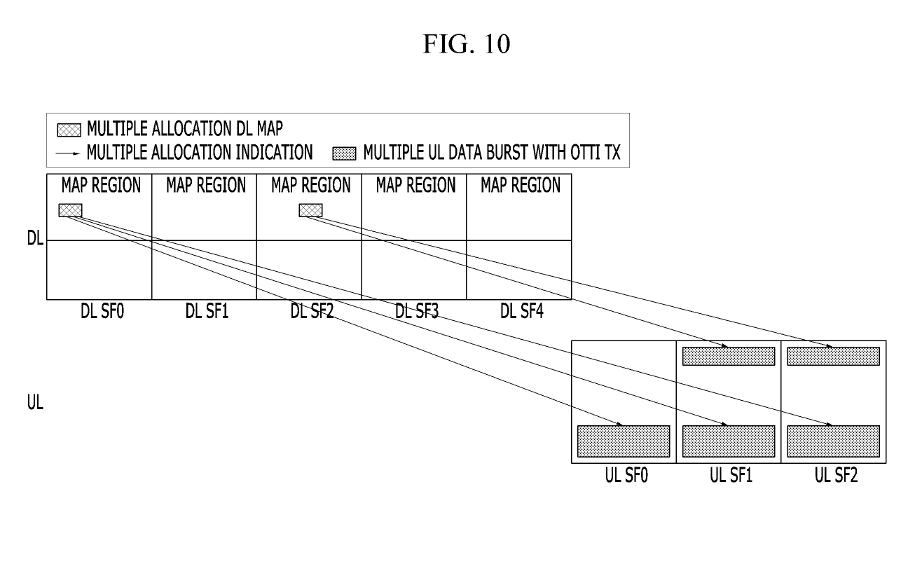

FIG. 10 shows an example of an uplink resource allocation method according to an embodiment of the present invention.

Referring to FIG. 10, a plurality of data bursts that are individually encoded with an OTTI length are allocated over a plurality of subframes, for example 3 subframes, using one UL MAP including multiple allocation control information at a downlink subframe #0 (DL SF0). In addition, a plurality of data bursts that are individually encoded with the OTTI length are allocated over a plurality of subframes, for example 2 subframes, using one DL MAP at a downlink subframe #2 (DL SF2).

Table 5 represents an uplink HARQ timing in a resource allocation method according to an embodiment of the present invention. That is, Table 5 represents a transmitting/receiving timing for a transmission of each uplink data burst and a transmission of each downlink HARQ feedback when at least one uplink data burst is transmitted using one MAP.

TABLE 5

| | FDD | TDD |
|---|---|---|
| UL HARQ Subpacket (data burst) Tx | mᵣ = ceil(lᵣ + F/2) mod F where lᵣ = l + r. l is the reference to the DL subframe, starting from 0 for the first DL subframe and numbering up to F-1, where the MAP for single or multiple one TTI transmission is transmitted. r is the index of UL data burst (HARQ subpacket) to be allocated for single or multiple one TTI transmission. lᵣ is the reference to the DL subframe, starting from 0 for the first DL subframe and numbering up to (F-1). mᵣ is the reference to the UL subframe, starting from 0 for the first uplink subframe and numbering up to (F-1), where HARQ subpacket of index r begins its transmission F is the number of subframes by the frame configuration. | For D ≧ U $\begin{matrix}{m}_{r} = \{ \begin{matrix}0 , & for 0 \leq {l}_{r} < K \\ {l}_{r} - K , & for K \leq {l}_{r} < U + K \\ U - 1 , & for U + K \leq {l}_{r} < D\end{matrix} \\ where K = floor ( ( D - U ) / 2 ) ,\end{matrix}$ and for single burst lᵣ = l, and r = 0, for multiple burst $\begin{matrix}{l}_{r} = \{ \begin{matrix}l + r + K , & for l < K \\ l + r , & for l \geq K\end{matrix} \\ r = 0 , … , ( U + K - l - 1 )\end{matrix}$ For D < U and single burst Tx $\begin{matrix}{m}_{r} = \{ \begin{matrix}\{ 0 , … , {l}_{r} - K \} , & for {l}_{r} = 0 \\ {l}_{r} - K , & for 0 \leq {l}_{r} < D - 1 \\ \{ {l}_{r} - K , … , U - 1 \} , & for {l}_{r} = D - 1\end{matrix} , \\ where K = - ceil ( ( U - D ) / 2 ) , {l}_{r} = l , and r = 0.\end{matrix}$ For D < U and multiple burst Tx $\begin{matrix}{m}_{r} = \{ \begin{matrix}{l}_{r} - K , & for r < D - 1 \\ \{ {l}_{r} - K , … , U - 1 \} , & for r \geq D - 1\end{matrix} , \\ where\end{matrix}$ $\begin{matrix}K = - ceil ( ( U - D ) / 2 ) , \\ {l}_{r} = \{ \begin{matrix}l + r , & for r < D - 1 \\ D - 1 , & for r \geq D - 1\end{matrix} \\ r = 0 , … , ( U + K - l - 1 )\end{matrix}$ l is the reference to the DL subframe, starting from 0 for the first DL subframe and numbering up to (D-1), where the MAP for single or multiple one TTI transmission is transmitted. r is the index of UL data burst (HARQ subpacket) to be allocated for single or multiple one TTI transmission. lᵣ is the reference to the DL subframe, starting from 0 for the first DL subframe and numbering up to (D-1). mᵣ is the reference to the UL subframe, starting from 0 for the first uplink subframe and numbering up to (U-1), where HARQ subpacket of index r begins its transmission |
| DL HARQ | nᵣ = lᵣ | nᵣ = lᵣ |
| feedback Tx | nᵣ is the reference to the DL | nᵣ is the reference to the DL subframe, |
| | subframe, starting from 0 for the first | starting from 0 for the first DL subframe |
| | DL subframe and numbering up to | and numbering up to (D-1), where the |
| | (F-1), where the HARQ | HARQ acknowledgement is sent. |
| | acknowledgement is sent. | |
| UL HARQ | mᵣ | mᵣ |
| Subpacket | | |
| (data burst) | | |
| ReTx | | |

In Table 5, a parameter I represents an index to a downlink subframe where one UL MAP including uplink resource allocation information for one or more downlink data bursts is transmitted. The parameter I starts from 0 for the first downlink subframe index, and numbers up to (D−1) in the TDD mode and to (F−1) in the FDD mode.

A parameter r represents a burst index to the one or more uplink data bursts. When the number of downlink subframes is greater than or equal to the number of uplink frames (D≧U), the parameter r is given as r=0 for the case that the number of uplink data bursts is 1, and r=0, 1, . . . , (U+K−I−1) for the case that the plurality of data bursts are multiplely allocated. When the number of downlink subframes is less than the number of uplink frames (D<U), the parameter r is given as r=0 for the case that the number of uplink data bursts is 1, and r=0, . . . , (I−K) for I=0, r=0, . . . , (U+K−I−1) for I=D−1 and r=0 for 0<I<D−1 in the case that the plurality of data bursts are multiplely allocated. In the FDD frame, the parameter r is given as r=0 for the case that the number of uplink data bursts is 1, and r=0, 1, . . . , (F−I−1) when the plurality of data bursts are multiplely allocated. For example, r=0 represents the burst index for the first data burst, and r=1 represents the burst index for the second data burst among the multiple data bursts.

A parameter Iᵣ represents an index that is a sum of the downlink subframe index I corresponding to a transmission time of the UL MAP including the uplink data burst allocation information and the burst index r. The parameter Iᵣ I starts from 0 for the first downlink subframe index, and numbers up to (D−1) in the TDD mode and to (F−1) in the FDD mode. In other words, the parameter Iᵣ a virtual subframe index for obtaining an uplink HARQ timing of uplink data bursts that are multiplely allocated, and the virtual subframe index for a transmission time of the allocation information signal for each of the multiple data bursts, i.e., the UL MAP.

A parameter mᵣ represents an index to an uplink subframe where an uplink data burst (uplink HARQ subpacket) corresponding to the burst index r is transmitted.

As such, when the plurality of downlink data bursts are multiplely allocated, the index r is determined by the number (U for TDD or F for FDD) of uplink subframes and an index I to the downlink subframe where the UL MAP, which is the allocation information signal of the data bursts, is transmitted. This means that the number of multiple uplink data bursts is determined by the index r.

The maximum number of uplink data bursts that can be transmitted using one UL MAP including multiple allocation information at one frame is a difference between the number of uplink subframes and the index I to the subframe where the UL MAP is transmitted, and is (U−1) for the TDD mode and (F−1) for the FDD mode.

A parameter nᵣ represents an index to a subframe where an HARQ feedback corresponding to the index r is transmitted, i.e., an HARQ feedback subframe index. For the downlink HARQ feedback of the uplink data burst (HARQ subpacket), the parameter nᵣ starts from 0 for the first downlink subframe index, and numbers up to (D−1) in the TDD mode and to (F−1) in the FDD mode.

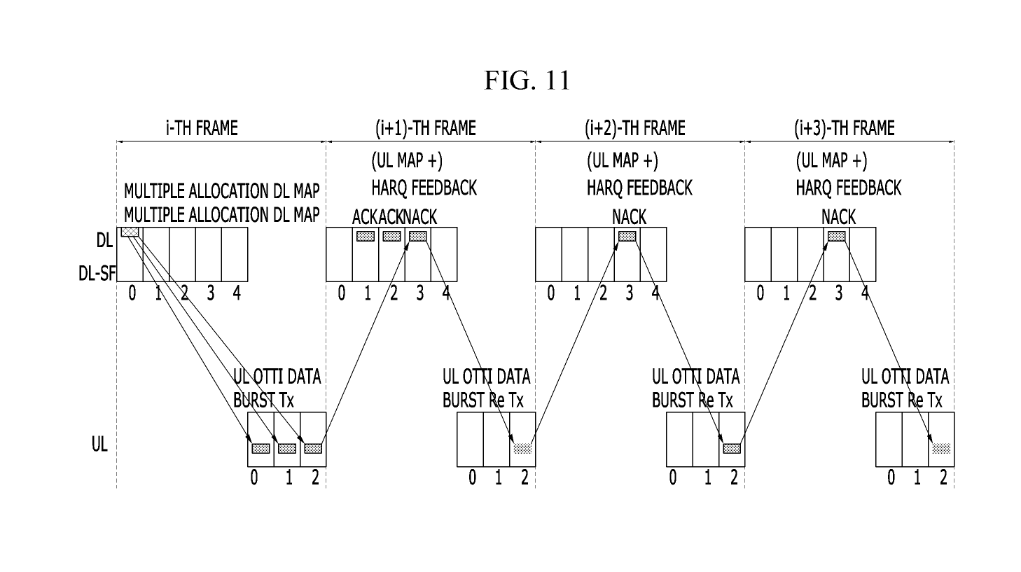

FIG. 11 shows an example of an HARQ process in an uplink resource allocation method according to an embodiment of the present invention.

Referring to FIG. 11, a base station allocates a plurality of data bursts to a mobile station with an OTTI length over a plurality of uplink subframes, for example 5 uplink subframes, using one UL MAP including uplink multiple allocation control information at a downlink subframe #1 (DL SF1) of the i-th frame.

When an error occurs at the uplink data burst corresponding to the third uplink subframe #2 (UL SF2) of the i-th frame, the base station transmits an HARQ feedback which is a NACK signal at the fourth downlink subframe #3 (DL SF3) of the (i+1)-th frame which is a next frame, and the mobile station retransmits the corresponds data burst at the same uplink subframe (UL SF2) of the (i+1)-th frame.

When the number of retransmissions is 2 as the example of FIG. 8, latency for the base station to finally receive all data bursts is 4 frames.

Because the latency for one transmission of the LTTI data burst is 4 frames in the example of FIG. 5, transmitting the data burst by multiple allocation method shown in FIG. 11 is more efficient than the LTTI data burst transmission when the same number of retransmission is used. Furthermore, the multiple allocation method can provide the same transmission speed as an OTTI transmission, and can allocate and transmit/receive multiple data bursts using one MAP thereby reducing the overhead of the UL MAP for a plurality of uplink data burst allocations.

As described above, according to an embodiment of the present invention, at least one data burst can be allocated and transmitted/received using one MAP. Accordingly, the overhead for allocating a plurality of data bursts can be reduced, and a gain of the radio resource can be improved by the decrease of the overhead.

Further, almost the same diversity channel characteristic can be achieved when data packets are transmitted at a resource allocation region of a frequency diversity channel, and transmission efficiency can be improved by a band AMC when the data packets are transmitted at a resource allocation region of a frequency band selection channel.

Furthermore, because only the data burst that has the OTTI length and corresponds to a subframe where the error occurs is retransmitted, the latency due to the retransmission can be reduced. As a result, a delay of a completion time of pack transmission can be reduced, and a buffer waiting time can be reduced for a data burst of a transmitting side.

Moreover, one MAP can provide a generalized downlink/uplink transmitting/receiving for a plurality of data burst such that a system can be easily designed.

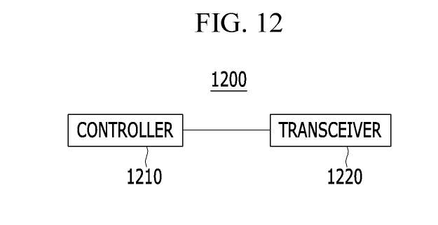

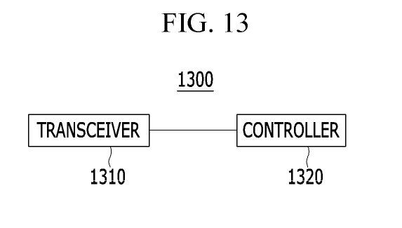

Next, a resource allocation apparatus for performing a resource allocation method according to an embodiment of the present invention is described with reference to FIG. 12 and FIG. 13.

FIG. 12 is a block diagram showing a resource allocation apparatus according to an embodiment of the present invention.

Referring to FIG. 12, a resource allocation apparatus 1200 includes a controller 1210 and a transceiver 1220. The resource allocation apparatus 1200 may be formed in a base station, or may be the base station itself.

The controller 1210 allocates one or more radio resources for transmitting one or more data bursts to one or more consecutive subframe, respectively, and generates a DL MAP or an UL MAP including allocation information on the one or more radio resources. The transceiver 1220 transmits the DL MAP or UL MAP at one downlink subframe. The transceiver 1220 consecutively transmits one or more downlink data bursts at the one or more allocated downlink subframes, or receives one or more uplink data bursts at the one or more allocated uplink subframes.

FIG. 13 is a block diagram showing a receiving apparatus of a resource allocation information signal according to an embodiment of the present invention.

Referring to FIG. 13, a receiving apparatus 1300 includes a transceiver 1310 and a controller 1320. The receiving apparatus 1300 may be formed in a mobile station, or may be the mobile station itself.

The transceiver 1310 receives a DL MAP or an UL MAP through one downlink subframe from a base station. The controller 1320 decodes and acquires the DL MAP or UL MAP. The DL MAP or UL MAP includes allocation information on one or more radio resources for transmitting one or more data bursts in one frame, and the one or more radio resources are allocated to one or more consecutive subframes, respectively. The transceiver 1220 transmits one or more uplink data bursts at the one or more allocated uplink subframes, or receive one or more downlink data bursts at the one or more allocated downlink subframes.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method of allocating a resource by a base station, the method comprising:
allocating a plurality of radio resources for transmitting a plurality of data bursts to a plurality of subframes in one frame, respectively;
generating a resource allocation information signal including allocation information on the plurality of radio resources; and
transmitting the resource allocation information signal to a mobile station through one subframe.

2. The method of claim 1, wherein a length of each data burst is a transmission time interval corresponding to one subframe.

3. The method of claim 1, wherein the one frame includes a plurality of downlink subframes and a plurality of uplink subframes,
the one subframe is a subframe having an index I among the plurality of downlink subframes,
a data burst having an index r among the plurality of data bursts is transmitted at a subframe having an index Iᵣ among the plurality of downlink subframes,
Iᵣ is defined as (I+r), and
I and r each are an integer that is greater than or equal to 0.

4. The method of claim 3, further comprising receiving a feedback signal on the data burst having the index r from the mobile station,
wherein the feedback signal is transmitted at a subframe having an index nᵣ among the plurality of uplink subframes,
for D>U, nᵣ is defined as below,
$${n}_{r} = \{ \begin{matrix} 0 , & for 0 \leq {l}_{r} < {K}_{1} \\ {l}_{r} - {K}_{1} , & for {K}_{1} \leq {l}_{r} < U + {K}_{1} \\ U - 1 , & for U + {K}_{1} \leq {l}_{r} < D ,\end{matrix}$$
for D≦U, nᵣ is defined as Iᵣ−K₂,
D represents a number of the plurality of downlink subframes,
U represents a number of the plurality of uplink subframes,
K₁ is defined as floor((D−U)/2),
K₂ is defined as −ceil((U−D)/2), and
r starts from 0 and numbers up to D−I−1.

5. The method of claim 1, wherein the one frame includes a plurality of FDD subframes,
the one subframe is a subframe having an index I among the plurality of FDD subframes,
a data burst having an index r among the plurality of data bursts is transmitted at an FDD subframe having an index Iᵣ among the plurality of FDD subframes,
Iᵣ is defined as (1+r), and
I and r each are an integer that is greater than or equal to 0.

6. The method of claim 5, further comprising receiving a feedback signal on the data burst having the index r from the mobile station,
wherein the feedback signal is transmitted at an FDD subframe having an index nᵣ among the plurality of FDD subframes,
nᵣ is defined as ceil(Iᵣ+F/2) mod F,
F represents a number of the plurality of FDD subframes, and
r starts from 0 and numbers up to F−I−1.

7. The method of claim 1, further comprising transmitting a feedback signal on a data burst having an index r among the plurality of data bursts to the mobile station,
wherein the one frame includes a plurality of downlink subframes and a plurality of uplink subframes,
the one subframe is a subframe having an index I among the plurality of downlink subframes,
the feedback signal is transmitted at a subframe having an index Iᵣ among the plurality of uplink subframes,
for D≧U, Iᵣ is defined as below,
$${l}_{r} = \{ \begin{matrix}l + r + {K}_{1} , & for l < {K}_{1} \\ l + r , & for l \geq {K}_{1} ,\end{matrix} \\ r = 0 , … , ( U + {K}_{1} - l - 1 )$$
for D<U, Iᵣ is defined as below,
$${l}_{r} = \{ \begin{matrix}l + r , & for r < D - 1 \\ D - 1 , & for r \geq D - 1 ,\end{matrix} \\ r = 0 , … , ( U + {K}_{2} - l - 1 )$$
D represents a number of the plurality of downlink subframes,
U represents a number of the plurality of uplink subframes,
K₁ is defined as floor((D−U)/2), and
K₂ is defined as −ceil((U−D)/2).

8. The method of claim 7, wherein the data burst having the index r is transmitted at a subframe having an index mᵣ among the plurality of uplink subframes,
for D≧U, mᵣ is defined as below,
$${m}_{r} = \{ \begin{matrix}0 , & for 0 \leq {l}_{r} < {K}_{1} \\ {l}_{r} - {K}_{1} , & for {K}_{1} \leq {l}_{r} < U + {K}_{1} \\ U - 1 , & for U + {K}_{1} \leq {l}_{r} < D ,\end{matrix}$$
for D<U, mᵣ is defined as below,
$${m}_{r} = \{ \begin{matrix}{l}_{r} - K , & for r < D - 1 \\ \{ {l}_{r} - K , … , U - 1 \} , & for r \leq D - 1.\end{matrix}$$

9. The method of claim 8, further comprising retransmitting the data burst having the index r at a subframe having the index mᵣ among a plurality of uplink subframes of a next frame when the feedback signal is a NACK.

10. The method of claim 1, further comprising transmitting a feedback signal on a data burst having an index r among the plurality of data bursts to the mobile station,
wherein the one frame includes a plurality of FDD subframes,
the one subframe is a subframe having an index I among the plurality of FDD subframes,
the feedback signal is transmitted at a subframe having an index Iᵣ among a plurality of FDD subframes included in a next frame of the one frame,
Iᵣ is defined as (1+r), and
I and r each are an integer that is greater than or equal to 0.

11. The method of claim 10, wherein the data burst having the index r is transmitted at an FDD subframe having an index mᵣ among the plurality of FDD subframes,
mᵣ is defined as ceil(Iᵣ+F/2) mod F,
F represents a number of the plurality of FDD subframes,
r starts from 0 and numbers up to F−I−1.

12. The method of claim 11, further comprising retransmitting the data burst having the index r at an FDD subframe having the index mᵣ among the plurality of FDD subframes of the next frame when the feedback signal is a NACK.

13. A method of receiving a resource allocation information signal from a base station by a mobile station, the method comprising:
receiving the resource allocation information signal from the base station through one subframe; and
acquiring the resource allocation information signal at the one subframe,
wherein the resource allocation information signal includes allocation information on a plurality of radio resources, for a plurality of data bursts, which are allocated to a plurality of subframes in one frame, respectively.

14. The method of claim 13, wherein a length of each data burst is a transmission time interval corresponding to one subframe.

15. The method of claim 13, wherein the one frame includes a plurality of downlink subframes and a plurality of uplink subframes,
the one subframe is a subframe having an index I among the plurality of downlink subframes,
a data burst having an index r among the plurality of data bursts is transmitted at a subframe having an index Iᵣ among the plurality of downlink subframes,
Iᵣ is defined as (I+r), and
I and r each are an integer that is greater than or equal to 0.

16. The method of claim 13, wherein the one frame includes a plurality of FDD subframes,
the one subframe is a subframe having an index I among the plurality of FDD subframes,
a data burst having an index r among the plurality of data bursts is transmitted at an FDD subframe having an index Iᵣ among the plurality of FDD subframes,
Iᵣ is defined as (I+r), and
I and r each are an integer that is greater than or equal to 0.

17. The method of claim 13, further comprising receiving a feedback signal on a data burst having an index r among the plurality of data bursts from the base station,
wherein the one frame includes a plurality of downlink subframes and a plurality of uplink subframes,
the one subframe is a subframe having an index I among the plurality of downlink subframes,
the feedback signal is transmitted at a subframe having an index Iᵣ among the plurality of uplink subframes,
Iᵣ is defined as (I+r), and
I and r each are an integer that is greater than or equal to 0.

18. The method of claim 13, further comprising receiving a feedback signal on a data burst having an index r among the plurality of data bursts from the base station,
wherein the one frame includes a plurality of FDD subframes,
the one subframe is a subframe having an index I among the plurality of FDD subframes,
the feedback signal is transmitted at a subframe having an index Iᵣ among a plurality of FDD subframes included in a next frame of the one frame,
Iᵣ is defined as (1+r), and
I and r each are an integer that is greater than or equal to 0.

19. An apparatus for allocating a resource, the apparatus comprising:
a controller configured to allocate a plurality of radio resources for transmitting a plurality of data bursts to a plurality of subframes in one frame, respectively, and to generate a resource allocation information signal including allocation information on the plurality of radio resources; and
a transceiver configured to transmit the resource allocation information signal to a mobile station through one subframe.

20. A receiving apparatus, comprising:
a transceiver configured to receive a resource allocation information signal from a base station through one subframe; and
a controller configured to acquire the resource allocation information signal at the one subframe,
wherein the resource allocation information signal includes allocation information on a plurality of radio resources, for a plurality of data bursts, which are allocated to a plurality of subframes in one frame, respectively.
